(19) United States
(12) Patent Application Publication
(10) Pub. No.: US 2019/0002352 A1
(43) Pub. Date: Jan. 3, 2019

(54) METHOD FOR PRODUCING A SILICON CARBIDE SHAPED BODY

(71) Applicant: Evonik Degussa GmbH, Essen (DE)

(72) Inventors: Julia LYUBINA, Hanau (DE); Michael KROELL, Linsengericht (DE)

(73) Assignee: Evonik Degsussa GmbH, Essen (DE)

(21) Appl. No.: 16/065,194

(22) PCT Filed: Dec. 22, 2016
(86) PCT No.: PCT/EP2016/082426

§ 371 Date: Jun. 22, 2018

(30) Foreign Application Priority Data
Dec. 23, 2015 (DE) 10 2015 226 668.0

(51) Int. Cl. C04B 35/575; C04B 35/573; C04B 35/626

(52) U.S. Cl. CPC C04B 35/5755; C04B 35/573; C04B 35/62695; C04B 2235/3826; C04B 2235/428; C04B 2235/5445; C04B 2235/656; C04B 2235/6582; C04B 2235/549; C04B 2235/5409; C04B 2235/5454; C04B 2235/483

(57) ABSTRACT

The invention relates to a method for producing a shaped body that contains at least 85 vol. % crystalline silicon carbide and at most 15 vol. % silicon, comprising the following steps: a) providing a powdered mixture that contains at least 60 vol. % amorphous silicon carbide and at most 40 vol. % silicon having a crystallite size of 3-50 nm; b) shaping the mixture by b1) hot pressing, or b2) compacting at room temperature and subsequent sintering or hot pressing, wherein the sintering or hot pressing is carried out in an inert gas or vacuum at a temperature of at least 1400° C. The volume ratio SiC:Si in the powdered mixture is 95:5-99:1.

The invention relates to a process for producing a shaped silicon carbide body.

Silicon carbide is notable for a low density, low thermal expansion, good oxidation and corrosion resistance and high strength, high creep resistance, low coefficient of friction and high hardness. As a result, silicon carbide is suitable as a ceramic high-performance material for applications in the high-temperature sector.

Moldings of SiC can be produced by sintering. However, silicon carbide has only a low tendency to sinter, since it exhibits a high free energy of formation and exact tetrahedral coordination in the lattice. Sintering up to a density greater than 95% of the theoretical density is possible only with the addition of sintering aids at high temperatures of 1900 to 2200° C.

Possible sintering aids include compounds of boron, aluminum and yttrium, and also carbon. The results of the use of the sintering aids include a reduced strength of the shaped SiC body and contamination by the sintering aids themselves. The sintering aids are usually added to the SiC powder prior to the sintering.

Additionally known is the production of the shaped silicon carbide body by infiltration of silicon in the liquid state into the porous shaped silicon carbide and carbon bodies. In the liquid silicization of silicon carbide, liquid silicon is introduced into a porous silicon carbide body. For improvement of the silicon infiltration, pulverulent carbon is additionally introduced. Alternatively, prior to the silicon infiltration, carbon compounds which form a carbon layer on silicon carbide particles by pyrolysis are used. The infiltration of this body with liquid silicon leads to a dense body consisting of silicon carbide and silicon. It was an object of the present invention to provide a process which takes on the advantages of the sintering aids in the production of shaped silicon carbide bodies, but permits minimization of the proportion thereof in the shaped body.

The invention provides a process for producing a shaped body comprising at least 85% by volume of crystalline silicon carbide and not more than 15% by volume of silicon, comprising the steps of:
a) providing a pulverulent mixture comprising
   at least 60% by volume of amorphous silicon carbide, preferably at least 90% by volume, more preferably 90-98% by volume, and
   not more than 40% by volume of silicon, preferably not more than 10% by volume, more preferably 2-10% by volume, having a crystallite size of 3-50 nm, preferably 3-20 nm,
b) shaping the mixture by
   b1) hot pressing or
   b2) compacting at room temperature and subsequent sintering or hot pressing,
   wherein the sintering or hot pressing is effected under inert gas or under reduced pressure and at a temperature of at least 1400° C., preferably 1400-2200° C., more preferably 1900-2100° C.

An amorphous phase refers here to one having an x-ray diffractogram having at least one broad maximum, called an amorphous halo.

The phase components of the feedstocks and the products are determined by means of x-ray structure analysis.

The crystalline silicon carbide in the shaped body is mainly in the form of cubic SiC, also referred to as SiC-3C or β-sic, generally at 80-95% by weight. In addition, there are small proportions of hexagonal SiC phases.

The crystallite sizes are determined by what is called the “average grain size microstrain method” according to J. I. Langford, Proceedings of the International Conference on Accuracy in Powder Diffraction II, NIST Special Publication No. 846, eds. E. Prince and J. K. Stalick (U.S. GPO, Washington, D.C., 1992), page 110.

Hot pressing is a process for producing a shaped body in which a powder or powder compact is introduced between two rams that are used to generate pressure and is kept at a temperature high enough to cause sintering processes, diffusion processes, melting processes and/or creeping processes. The production of a shaped body by means of hot pressing is thus effected by simultaneous application of heat and pressure. In a standard hot pressing operation, the heat is generated by an external heating apparatus. Spark plasma sintering (SPS) is a variation of hot pressing in which the heat is not supplied from the outside, but is generated by application of electrical current. The advantages of SPS are shorter process times and lower temperatures that are required for the production of dense shaped bodies.

The configuration of an SPS system comprises an installation for generation of vertical uniaxial pressure, a water-cooled vacuum chamber and a pulsed direct current generator connected to two electrodes. The generator generates a defined pulsed voltage and current with a typical pulse duration in the order of magnitude of milliseconds, typically between 1 and 300 ms. Application of electrical voltages results in flow of high currents through the compact. This leads to heating via Joule heating. The uniaxial pressure for SPS can be generated by the upper and lower rams. Typical forces here are 50 to 360 kN. The powder material or a compact is introduced into a compression die made of graphite between graphite rams and held between the electrodes. Under pressure and as a result of application of pulsed current, the temperature of the material rises at a rate of up to 1000 K/min. SPS is conducted under an inert atmosphere (vacuum or inert gas). The SPS process is monitored by means of temperature measurement.

According to the material and peculiarities of the SPS system, the temperature difference between the material intended for sintering and the die or the rams may be several hundred kelvin (W. Yucheng, F. Zhengyi, Mater. Sci. Eng. B90 (2002) 34-37).

The pressure in the hot pressing operation is preferably 10-600 MPa, more preferably 20-250 MPa

The compaction can be effected by pressing at room temperature at a pressure of 10-600 MPa, preferably at 20-250 MPa. The compaction can also be effected from a suspension comprising the pulverulent mixture.

The best results are obtained by effecting the shaping by compaction at room temperature and subsequently sintering. Room temperature is understood to mean a temperature range of 25° C.±10° C.

With the proviso that the volume ratio of the SiC:Si phases in the pulverulent mixture is 95:5-99:1 and the temperature is higher than 1900° C., especially 2000-2100° C., the process is suitable for production of shaped silicon carbide bodies where no silicon is detectable any longer.

The pulverulent mixture used in the process of the invention may comprise, as well as amorphous silicon carbide and silicon, also small proportions of silicon oxides, microscale silicon, carbon or compounds of aluminum, yttrium or boron, and/or carbonaceous substances. Microscale silicon shall be understood to mean a silicon having a crystallite size of more than 100 nm.

In a preferred embodiment of the invention, the proportion of amorphous silicon carbide and silicon in a pulverulent mixture is at least 98% by volume, more preferably at least 99% by volume.

The proportion of the compounds of aluminum, yttrium or boron and/or carbonaceous substances that are known as sintering aids is preferably less than 10% by weight, more preferably less than 1% by weight. Very particular preference is given to an embodiment in which these compounds do not occur.

The BET surface area of the pulverulent mixture used is preferably 10-100 m²/g, more preferably 20-70 m²/g.

It is found that particularly good results are achieved when the pulverulent mixture is in the form of fused aggregates. The aggregates preferably have an average diameter of 50-500 nm.

A particularly suitable pulverulent mixture is one which is obtained by reacting, in a hot-wall reactor,

a gas stream comprising at least one starting compound of silicon selected from the group consisting of SiH₄, Si₂H₆ and Si₃H₈, and
a gas stream comprising at least one starting compound of carbon selected from the group consisting of methane, ethane, propane, ethylene and acetylene,
in a molar ratio of silicon:carbon of 1.5:1-1:3 at a temperature of 900-1200° C.,
cooling the reaction mixture or allowing it to cool and separating the pulverulent mixture from gaseous substances.

It is possible here to additionally introduce hydrogen into the hot-wall reactor. In general, the hydrogen is used in a 2-10-fold molar excess based on the sum total of the starting compounds of silicon and carbon. In addition, inert gases selected from the group consisting of argon and helium may additionally be introduced into the hot-wall reactor.

### EXAMPLES

### Starting Material

### Example 1: Production of a Pulverulent SiC/Si Mixture in a Hot-Wall Reactor

The present gas phase reactor has a coaxial nozzle system for introduction of the process gases. 5 slm (slm=standard liters per minute)

SiH₄ and 2.5 slm of acetylene are introduced into the core of a tubular hot-wall reactor as a homogeneous mixture via a nozzle. In addition, 35 slm of hydrogen are introduced as blanketing gas. There is a laminar flow through the hot wall reactor.

A temperature of 985° C. is measured at the outer reactor wall. The solids are separated from gaseous substances in a filter and dispensed under inert conditions via an airlock system.

The solids have a BET surface area of 67 m²/g, a volume ratio of SiC:Si of 96:4.

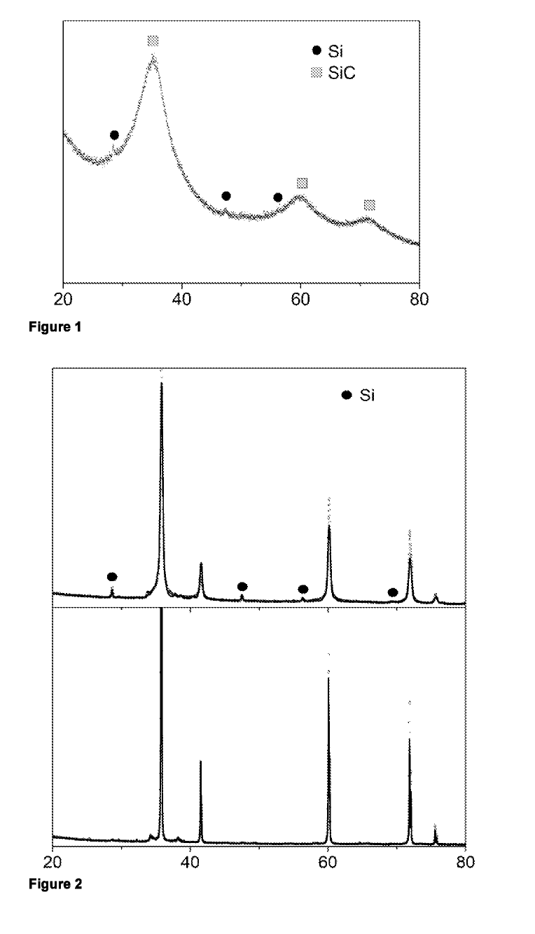

The crystallite size of Si is (8±4) nm. The SiC phase is characterized by three broad reflections. These broad reflections, also known as a halo, are characteristic of an amorphous phase (FIG. 1, x-axis: 2 theta [° ], y-axis: intensity [a.u.]). The composition of the amorphous phase may either correspond to stoichiometric SiC or differ from the SiC stoichiometry.

### Production of Shaped Bodies

### Example 2: Pressing at Room Temperature

The pulverulent Si/SiC mixture produced in example 1 is introduced into a compression die made of steel and pressed at room temperature. Two different dies are used: a cylindrical die having a diameter of 13 mm which is laden with about 0.3 g of pulverulent Si/SiC mixture, and a cuboidal die having dimensions of 10×16 mm, which is laden with about 0.5 g of pulverulent Si/SiC mixture. Sufficiently stable compacts were obtained after pressing at pressures of 20 to 80 MPa. The height of the compacts is about 3 mm.

### Example 3: Sintering at 2100° C.

The compacts produced in example 2 are introduced into a high-temperature oven. The oven is evacuated to a pressure of 10⁻²-10⁻³ mbar. The sintering is executed under an argon atmosphere to the temperature program detailed in table 1.

The oven is additionally equipped with an optical and thermogravimetric measurement system which allows in situ observation of the sintering characteristics.

In the course of heating, shrinkage of the compacts of 1% to 2% is observed at (820±40°) C. It is noted that this temperature corresponds to 0.6Tₘ where Tₘ is the melting temperature of pure silicon. The shrinkage at this temperature may be caused by a reaction between nanoscale Si and amorphous SiC, and also by SiC crystallization.

At a temperature of (1400±50°) C., further significant shrinkage of the compacts of 23% to 30% is observed. Above 1410° C., silicon in the Si/SiC mixture is liquid and therefore enables liquid phase sintering of SiC without addition of sintering aids. In addition, a loss of mass totaling 10% is observed above 1400° C. This may be due to formation of volatile species.

From the Rietveld refinement of the x-ray diffractograms (FIG. 2, bottom; x-axis: 2 theta [° ], y-axis: intensity [a.u.]), it is possible to calculate the proportions and lattice constants of the phases formed in the course of sintering in the end product (see table 2). According to the Rietveld refinement, the end product contains predominantly SiC-3C phase (86% by volume) and 13.9% by volume of hexagonal SiC phases. The phase proportion of Si of (0.1±0.4)% by volume is negligibly small.

Table 2 shows the results of the Rietveld refinement of the x-ray diffractograms: phase proportions, lattice constants and average crystallite size of SiC-3C in the end product. The error in the determination of phase proportions is 0.4% by volume.

### Example 4: Sintering at 1600° C.

The compacts produced in example 2 are introduced into a high-temperature oven. The oven is evacuated to a pressure of 10⁻²-10⁻³ mbar. The sintering is executed under an argon atmosphere to the temperature program detailed in table 1.

In the course of heating, shrinkage of the compacts of 2.2% is observed at (820±40°) C. At a temperature of (1400±50°) C., further significant shrinkage of the compacts of 19% is observed. In addition, a loss of mass totaling 0.2% is observed above 1400° C. This loss of mass is distinctly smaller than the loss of mass in example 2.

From the Rietveld refinement of the x-ray diffractograms (FIG. 2, top), it is possible to calculate the proportions and lattice constants of the phases formed in the course of sintering in the end product (see table 2). According to the Rietveld refinement, the end product contains predominantly SiC-3C phase (80% by volume) and 18.9% by volume of hexagonal SiC phases. The phase proportion of Si is (1.1±0.4)% by volume. This phase proportion of silicon is higher than in example 3, which may firstly be due to an incomplete reaction between nanoscale Si and amorphous SiC and a lesser degree of formation of volatile species.

By contrast with the end product in Example 3, the crystallite size of SiC-3C after sintering at 1600° C. is within the nanoscale range (table 2). This is advantageous for the strength of the end product.

### Example 5. Hot Pressing by Means of Spark Plasma Sintering (SPS) at 1400° C.

The pulverulent Si/SiC mixture produced in example 1 is introduced into a compression die made of graphite and pressed according to the temperature program detailed in table 3. SPS is conducted under reduced pressure. A pressure of 5 MPa is applied at room temperature. When the temperature of 1200° C. is attained, the pressure is increased continuously from 5 MPa to 24 MPa. The pressure of 24 MPa is kept constant at 1400° C. for 2 min. Subsequently, the temperature is reduced to 300° C. within a period of 10 min. The die, ram and material produced by means of SPS are subsequently cooled down to room temperature at the chamber cooling rate.

From the Rietveld refinement of the x-ray diffractograms, it is possible to calculate the proportions and the lattice constants of the phases formed in SPS in the end product (see table 4). According to the Rietveld refinement, the end product contains predominantly SiC-3C phase (97% by weight) and 3% by weight of hexagonal SiC phase. More particularly, no Si phase is observed. Thus, the material produced by SPS consists of 100% SiC. The crystallite size of SiC-3C after SPS at 1400° C. is within the nanoscale range (table 4).

The density of the shaped body determined by the Archimedes method is 3.05 g/cm³ and is thus above 96% of the theoretical density of 3C—SiC.

### Example 6. Hot Pressing by Means of Spark Plasma Sintering (SPS) at 1550° C.

The pulverulent Si/SiC mixture produced in example 1 is introduced into a compression die made of graphite and pressed according to the temperature program detailed in table 3. SPS is conducted under reduced pressure. A pressure of 6.5 MPa is applied at room temperature. When the temperature of 1200° C. is attained, the pressure is increased continuously from 6.5 MPa to 24 MPa. The pressure of 24 MPa is kept constant at 1550° C. for 2 min. Subsequently, the temperature is reduced to 300° C. within a period of 12 min. The die, ram and material produced by means of SPS are subsequently cooled down to room temperature at the chamber cooling rate.

From the Rietveld refinement of the x-ray diffractograms, it is possible to calculate the proportions and the lattice constants of the phases formed in SPS in the end product (see table 4). According to the Rietveld refinement, the end product contains predominantly SiC-3C phase (96% by weight) and 4% by weight of hexagonal SiC phase. More particularly, no Si phase is observed. Thus, the material produced by SPS consists of 100% SiC. The crystallite size of SiC-3C after SPS at 1550° C. is within the nanoscale range (table 4).

The density of the shaped body determined by the Archimedes method is 2.97 g/cm³ and is thus above 93% of the theoretical density of 3C—SiC.

TABLE 1
Temperature program for sintering

| | Example 3 | | Example 4 | |
|---|---|---|---|---|
| Heating from room temp. to 200° C. | 5 | K/min | 5 | K/min |
| Heating from 200 to 1300° C. | 20 | K/min | 20 | K/min |
| Heating from 1300 to 1600° C. | 2 | K/min | 2 | K/min |
| Hold time at 1600° C. | 0 | min | 30 | min |
| Heating from 1600 to 2100° C. | 10 | K/min | — | |
| Hold time at 2100° C. | 30 | min | — | |
| Cooling to 1100° C. | 10 | K/min | 10 | K/min |

| | | |
|---|---|---|
| Cooling below 1100° C. | Oven | Oven |
| | cooling rate | cooling rate |

TABLE 2
Phase proportions, lattice constants and grain size <D>
of the phases formed in the course of sintering

| Example | | 3 | 4 |
|---|---|---|---|
| SiC-3C | vol % | 86.0 | 80.0 |
| | a (Å) | 4.3613 | 4.3608 |
| Si | vol % | 0.1 | 1.1 |
| | a (Å) | 5.421 | 5.430 |
| SiC-21R | vol % | 4.3 | 18.9 |
| | a (Å) | 3.079 | 30.805 |
| | c (Å) | 54.77 | 53.73 |
| SiC-18H | vol % | 1.6 | 0 |
| | a (Å) | 3.085 | |
| | c (Å) | 44.1 | |
| SiC-6H | vol % | 8.0 | 0 |
| | a (Å) | 30.877 | |
| | c (Å) | 15.160 | |
| <D>_{SiC-3C} | nm | microcrystalline | 28 ± 2 |

TABLE 3
Temperature program for SPS

| | Example 5 | | Example 6 | |
|---|---|---|---|---|
| Heating from room temp. to 400° C. | 60 | K/min | 60 | K/min |
| Heating from 400 to 950° C. | 100 | K/min | 110 | K/min |
| Heating from 950 to 1400° C. | 40 | K/min | — | |
| Heating from 950 to 1550° C. | — | | 85 | K/min |
| Hold time at Tₘₐₓ = 1400° C. | 2 | min | — | |
| Hold time at Tₘₐₓ = 1550° C. | — | | 2 | min |
| Cooling from Tₘₐₓ to 300° C. | 10 | min | 12 | min |

| | | |
|---|---|---|
| Cooling below 300° C. | Chamber | Chamber |
| | cooling rate | cooling rate |

TABLE 4
Phase proportions, lattice constants and grain size
<D> of the phases formed in SPS

| Example | | 5 | 6 |
|---|---|---|---|
| SiC-3C | % by wt. | 97 | 96 |
| | a (Å) | 4.359 | 4.360 |
| Si | % by wt. | 0 | 0 |
| SiC-2H | % by wt. | 3 | 4 |
| | a (Å) | 3.046 | 3.074 |
| | c (Å) | 5.212 | 5.238 |
| <D>_{SiC-3C} | nm | 40 ± 5 | 30 ± 5 |

1. A process for producing a shaped body, the method comprising the steps of:
a) providing a pulverulent mixture comprising at least 60% by volume of amorphous silicon carbide and not more than 40% by volume of silicon having a crystallite size of from 3 to 50 nm, and
b) shaping the pulverulent mixture by either b1) hot pressing or b2) compacting at room temperature and subsequent sintering or hot pressing,
wherein the shaped body comprise at least 85% by volume of crystalline silicon carbide and not more than 15% by volume of silicon, and
the sintering or hot pressing is carried out under inert gas or reduced pressure at a temperature of at least 1400° C.

2. The process of claim 1,
wherein the pulverulent mixture comprises at least 90% by volume of amorphous silicon carbide and not more than 10% by volume of silicon.

3. The process of claim 1,
wherein the temperature is from 1900 to 2100° C.

4. The process of claim 1, wherein a volume ratio of SiC:Si in the pulverulent mixture is from 95:5 to 99:1 and the temperature is from 2000 to 2100° C.

5. The process claim 1,
wherein the pulverulent mixture consists to an extent of at least total 98% by weight of amorphous silicon carbide and silicon.

6. The process of claim 1,
wherein no sintering aids are used.

7. The process of claim 1, wherein a BET surface area of the pulverulent mixture is from 10 to 100 m²/g.

8. The process claim 1,
wherein the mixture is in the form of fused aggregates.

9. The process of claim 8,
wherein an average diameter of the fused aggregates is from 50 to 500 nm.

10. The process of claim 1,
wherein the pulverulent mixture is provided by,
in a hot-wall reactor,
reacting a gas stream comprising at least one starting compound of silicon selected from the group consisting of SiH₄, Si₂H₆ and Si₃H₈, and a gas stream comprising at least one starting compound of carbon selected from the group consisting of methane, ethane, propane, ethylene and acetylene in a molar ratio of silicon:carbon of from 1.5:1 to 1:3 at a temperature of from 900 to 1200° C., thereby forming a reaction mixture, and
cooling the reaction mixture or allowing the reaction mixture to cool and separating the pulverulent mixture from gaseous substances.

11. The process of claim 10,
wherein hydrogen is introduced into the hot-wall reactor.
